(19) United States
(12) Patent Application Publication
(10) Pub. No.: US 2019/0205000 A1
(43) Pub. Date: Jul. 4, 2019

(54) SYSTEM AND METHOD OF AN INTERACTIVE PLATFORM FOR SOLVING A PLURALITY OF PROBLEMS

(71) Applicant: Priya Raghavendran, CHENNAI (IN)

(72) Inventor: Priya Raghavendran, CHENNAI (IN)

(21) Appl. No.: 15/905,659

(22) Filed: Feb. 26, 2018

(30) Foreign Application Priority Data
Jan. 4, 2018 (IN) 201841000444

(51) Int. Cl. G06F 3/0484; G06Q 30/02

(52) U.S. Cl. CPC G06F 3/0484; G06Q 30/0277; G06Q 30/0239

(57) ABSTRACT

System and method of an interactive platform for solving a plurality of problems is provided. The system includes a subscription module which is configured to register a plurality of problem facing users and a plurality of solution providing users, to generate a unique identification code. The system also includes a problem broadcast module configured to provide a platform for the plurality of problem facing users to share a plurality of problems, a solution broadcast module configured to provide a platform for the solution providing users to provide a plurality of solutions, an interaction module configured to provide an interaction between the plurality of problem facing users and the plurality of solution providing users, an incentive module configured to provide an incentive to the plurality of problem facing users and to the plurality of solution providing users, a user interface configured to transmit information between the aforementioned modules via communication network.

### BACKGROUND

Embodiments of the present disclosure relates to a problem solution mechanism, more particularly to, a system and method of an interactive platform for solving a plurality of problems.

All individuals face different kinds of issues and problems during their journey of life. These may include moral issues, financial issues, public issues, legal issues, medical issues, academic etc. There are many ways in which an individual may seek to get solutions or suggestions for such issues. Receiving the right guidance and understanding the right way to sort out the issue will help the individual in going forward. Most people tend to confide in close relations who include friends, family, acquaintances, etc. to receive solutions, and in this case the experiences and knowledge of a person would help in providing a solution or suggestion. Another way of getting a solution is to approach support from experts or professionals in known circles. Experts and professionals would provide more credible information, but finding the right professional with genuine interests could be challenging. Lastly, an individual may also get help through a search engine, or other online communities. These online communities may provide solutions but the credibility of such responses may be questionable.

Most of the queries or issues raised by an individual may be answered or solved in some way of the other, but the accessibility and credibility of the answer may be uncertain. There may be several platforms which offer solutions or suggestion to issues, but may not provide any form of reward to the users. Having a platform for both problem facing individuals and solution providing individuals would be helpful for several people. Also, by providing a rating system, it would increase the credibility of a certain individual wherein the solutions proposed by certain individuals would be considered highly credible. Providing a rating system or a reward system encourages individual to provide credible solution and suggestions in order to gain credibility among users.

Hence, there is a need for an improved and alternative platform for solving a plurality of problems to address the aforementioned issues.

### BRIEF DESCRIPTION

In accordance with one embodiment of the disclosure, a system and method of an interactive platform for solving a plurality of problems is provided. The system includes a subscription module which is configured to register a plurality of problem facing users, and also configured to register a plurality of solution providing users, wherein the subscription module is configured to generate a unique identification code. The system also includes a problem broadcast module which is configured to provide a platform for the plurality of problem facing users to share a plurality of problems, and the platform is also configured to publish the plurality of problems, wherein the plurality of problems is accessed by the plurality of solution providing users. The system further includes a solution broadcast module configured to provide a platform for the solution providing users to provide a plurality of solutions, wherein the solution broadcast module is further configured to display the plurality of solutions of the plurality of problems to a specific user of the plurality of problem facing users.

According to a further embodiment, the system also includes an interaction module configured to provide an interaction between the plurality of problem facing users and the plurality of solution providing users. The system also includes an incentive module configured to provide an incentive amount to the plurality of problem facing users and is further configured to provide an incentive amount to the plurality of solution providing users. The system further includes a user interface configured to transmit information between the subscription module, the problem broadcast module, the solution broadcast module, the interaction module, and the incentive module via a communication network.

In accordance with a further embodiment of the present disclosure a method for an interactive platform for solving a plurality of problems is provided. The method includes registering a plurality of problem facing users and further registering a plurality of solution providing users through a subscription module, wherein the subscription module is configured to generate a unique identification code. The method includes providing a platform for the plurality of problem facing users to share a plurality of problems through a problem broadcast module, wherein the platform is configured to publish the plurality of problems, and wherein the plurality of problems is accessed by the plurality of solution providing users. The method also includes providing a platform for the solution providing users to provide a plurality of solutions through a solution broadcast module, wherein the solution broadcast module is further configured to display the plurality of solutions of the plurality of problems to a specific user of the plurality of problem facing users.

According to a further embodiment, the method includes interacting of the plurality of problem facing users with the plurality of solution providing users through an interaction module. The method also includes providing an incentive amount to the plurality of problem facing users and further providing an inventive amount to the plurality of solution providing users through an incentive module. The method further includes transmitting information between the subscription module, the problem broadcast module, the solution broadcast module, the interaction module, and the incentive module via a communication network through a user interface module.

### BRIEF DESCRIPTION OF THE DRAWINGS

The disclosure will be described and explained with additional specificity and detail with the accompanying figures in which:

FIG. 1 illustrates a block diagram of a system for an interactive platform for solving a plurality of problems in accordance with an embodiment of the present disclosure;

FIG. 2 illustrates a process flow diagram of a method for an interactive platform for solving a plurality of problems in accordance with an embodiment of the present disclosure.

FIG. 3 illustrates an exemplary embodiment of an interactive platform for solving a plurality of problems in accordance with an embodiment of the present disclosure. FIG. 3 further illustrates various user interfaces of the platform including ThinXoluation 110, ThinXtore 120, and ThinXpert 130.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present disclosure will be described below in detail with reference to the accompanying figures.

Embodiments of the present disclosure relate to a system and method of an interactive platform for solving a plurality of problems. The system includes a subscription module which is configured to register a plurality of problem facing users, and also configured to register a plurality of solution providing users, wherein the subscription module is configured to generate a unique identification code. The system also includes a problem broadcast module which is configured to provide a platform for the plurality of problem facing users to share a plurality of problems, and the platform is also configured to publish the plurality of problems, wherein the plurality of problems is accessed by the plurality of solution providing users. The system further includes a solution broadcast module configured to provide a platform for the solution providing users to provide a plurality of solutions, wherein the solution broadcast module is further configured to display the plurality of solutions of the plurality of problems to a specific user of the plurality of problem facing users.

According to a further embodiment, the system includes an interaction module configured to provide an interaction between the plurality of problem facing users and the plurality of solution providing users. The system also includes an incentive module configured to provide an incentive amount to the plurality of problem facing users and is further configured to provide an incentive amount to the plurality of solution providing users. The system further includes a user interface configured to transmit information between the subscription module, the problem broadcast module, the solution broadcast module, the interaction module, and the incentive module via a communication network.

In the following specification and the claims, reference will be made to a number of terms, which shall be defined to have the following meanings. The singular forms “a”, “an”, and “the” include plural references unless the context clearly dictates otherwise.

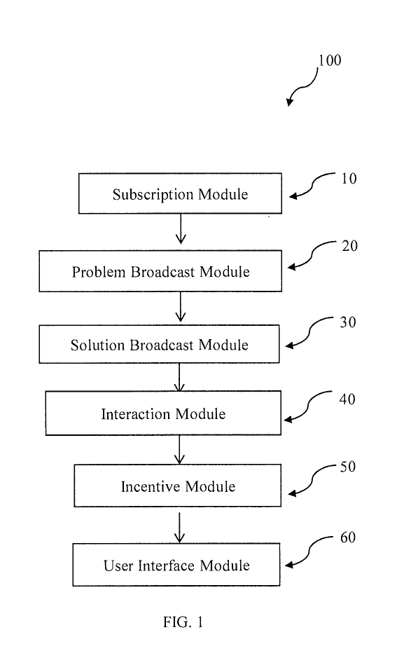

The present disclosure relates to a system and method of an interactive platform for solving a plurality of problems. FIG. 1 illustrates a block diagram of a system for an interactive platform for solving a plurality of problems in accordance with an embodiment of the present disclosure. The system (100) includes a subscription module (10) configured to register a plurality of problem facing users, and further configured to register a plurality of solution providing users, wherein the subscription module (10) is configured to generate a unique identification code. The plurality of problem facing users and the plurality of solution providing user are given a specific login credential or an OTP validation to access the subscription.

According to another embodiment, the system (100) also includes a problem broadcast module (20) configured to provide a platform for the plurality of problem facing users to share a plurality of problems, wherein, the platform is configured to publish the plurality of problems, and wherein the plurality of problems is accessed by the plurality of solution providing users. The problem broadcast module (20) allows the plurality of problem facing individuals to focus & articulate their genuine problems in a way that is understandable to other users. The problem broadcast module (20) captures the plurality of problems in plain text in either a mobile or web user interface by a plurality of problem facing users. There would be simple text with an option to enter relevant criteria if any, and relevant remarks if any.

According to a further embodiment, the problem broadcast module (20) will capture the key words or key topics based on artificial intelligence and natural language processing. Based on the topics, the plurality of problems will be broadcasted with a click of a post button. The problem broadcast module (20) is then configured to broad-cast the plurality of problems to all the users who have subscribed to the platform, and these users may include experts in a specific field, passionate individuals, or academically eligible individuals, etc. based on the topics or key words identified. Therefore the plurality of problems will be broadcast to the users who are related to the topics or keywords that are identified.

According to another embodiment, the system (100) includes a solution broadcast module (30) configured to provide a platform for the solution providing users to provide a plurality of solutions, wherein the solution broadcast module (30) is further configured to display the plurality of solutions of the plurality of problems to a specific user of the plurality of problem facing users. The plurality of solution providing users may provide their solution considering the details and remarks provided by the plurality of problem facing users. Further, the problem facing user will be notified regarding the solutions provided by the plurality of solution providing users.

According to a further embodiment, the system (100) also includes an interaction module (40) configured to provide an interaction between the plurality of problem facing users and the plurality of solution providing users. The interaction module (40) further comprises a one-on-on interaction module, wherein the one-on-one interaction module is configured to provide a one-on-one interaction between a first specific user of a plurality of problem facing users and a second specific user of a plurality of solution providing users. The plurality of problem facing users have the option to directly interact with a specific user of the plurality of solution providing users, to get a plurality of solutions for the plurality of problems.

According to another embodiment, once the plurality of solutions are provided by the plurality of solution providing users, and the plurality of problem facing users are satisfied with the plurality of solutions; the plurality of problem facing users are given the option to close the process of a specific problem.

According to a preferred embodiment, the system (100) further includes an incentive module (50) configured to provide an incentive amount to the plurality of problem facing users and is further configured to provide an incentive amount to the plurality of solution providing users. The incentive module (50) further comprises an incentive calculation module, wherein the incentive calculation module is configured to calculate the incentive amount based on a criterion of ratings of the plurality of problem facing users and the plurality of solution providing users. Once the plurality of solution providing users provides a plurality of solutions, the plurality of problem facing users are given the option to rate the plurality of solutions provided to them, based on how well the solution was helpful in resolving the problem. Once a specific user of the plurality of problem facing users closes the process for a specific problem of a plurality of problems, the incentive amount is calculated based on a criterion of ratings and the incentive amount is provided to the plurality of problem facing users and the plurality of solution providing users based on the ratings.

According to yet another embodiment, the system (100) also includes a user interface (60) configured to transmit information between the subscription module, the problem broadcast module, the solution broadcast module, the interaction module, and the incentive module via a communication network. The user interface (60) may include one of a mobile phone, a laptop, a notebook computer, a personal data assistant (PDA) and the like capable of connecting to the Internet and having other communication capabilities. The user interface (60) may communicate through a communication network through the wireless network/internet or wired connections or a combination thereof. It will be appreciated by those skilled in the art that the user interface (60) includes one or more functional elements capable of communicating through the communication network to request and receive one or more services.

According to a preferred embodiment of the system (100), the communication network may be a wireless or wired network, or a combination thereof. Wireless network may include long range wireless radio, wireless personal area network (WPAN), wireless local area network (WLAN), mobile data communication such as 3G, 4G or any other similar technologies. The communication module (40) may be implemented as one of the different types of networks, such as intranet, local area network (LAN), wide area network (WAN), the internet, and the like. The communication network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Further the communication network may include a variety of network devices, including routers, bridges, servers, computing devices, storage devices, and the like.

According to another embodiment, the system also includes an advertisement module wherein the advertisement module is configured to provide a platform for a plurality of users to advertise a plurality of products and services, wherein the advertisement module is coupled to the incentive module further configured to provide the incentive amount based on an advertisement of the plurality of products and services. The plurality of problem facing users and the plurality of solution providing users are provided with an option to advertise a plurality of products and services. The incentive amount received through the incentive module may be used to exchange the incentive amount for the plurality of products and services. If the incentive amount for any user reaches more than a specific amount, the incentive amount may be used to redeem a gift coupon or can be exchanged for cash. Also, the products and services may be any suggestions, tips, ideas, links to innovations or any other like.

According to a further embodiment, examples of services could include, a user who is an expert in cooking could post few recipes in exchange for the incentive amount. A contractor could provide “free inspection of any issue in home interior” in exchange for the incentive amount. A tax professional could place “tax tool” in exchange for the incentive amount. etc. An example of products could include a user posting their unused books in exchange for the incentive amount, a user posting items like blue tooth speakers or other items which they think could be useful for others in exchange for the incentive amount. This encourages a sharing community between the users.

According to yet another embodiment, the system also includes a hall of fame module wherein the hall of fame module is configured to list the plurality of solution providers who possess a higher criterion of ratings. Providing ratings will help users leverage in selling or marketing their services to others. For e.g., a person who is an IT professional solving problems on a regular basis may be listed in the hall of fame module, any individual wanting to engage a person from the hall of fame module may do so for freelancing if required. This would be a platform for recognising people who are passionate and have earned credibility through their solution mind-set.

According to a further embodiment, the system also includes a grouping module, wherein the grouping module is configured to bring together a group of people from the plurality of solution providers to work towards a specific problem of a plurality of problems, as per the time period provided by the plurality of problem facing individuals. Having a group of solution providers processing the plurality of problems would provide combined experience, expertise and credibility, leading to a provide a thorough plurality of solutions which would be beneficial to the problem facing individual.

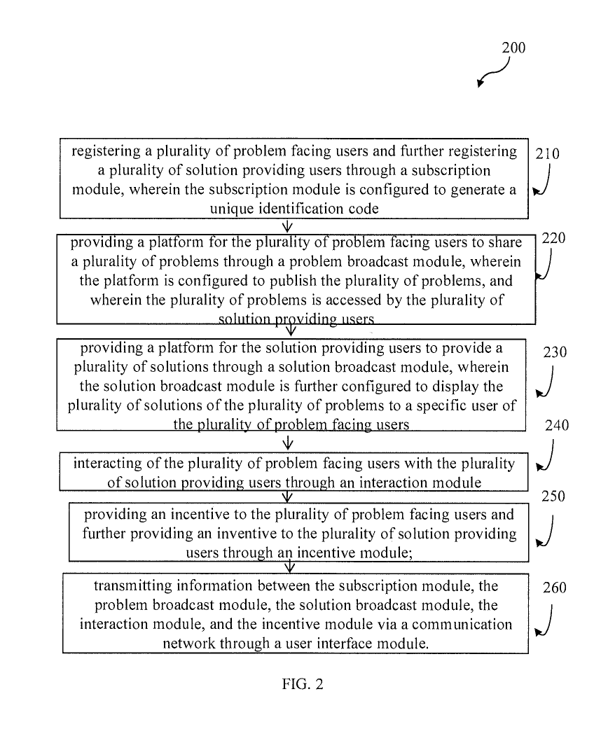

FIG. 2 illustrates a process flow diagram of a method for an interactive platform for solving a plurality of problems in accordance with an embodiment of the present disclosure. The method (200) includes registering a plurality of problem facing users and further registering a plurality of solution providing users through a subscription module, wherein the subscription module is configured to generate a unique identification code in step 210

According to a further embodiment the method includes providing a platform for the plurality of problem facing users to share a plurality of problems through a problem broadcast module, wherein the platform is configured to publish the plurality of problems and wherein the plurality of problems is accessed by the plurality of solution providing users in step 220.

The method also includes providing a platform for the solution providing users to provide a plurality of solutions through a solution broadcast module, wherein the solution broadcast module is further configured to display the plurality of solutions of the plurality of problems to a specific user of the plurality of problem facing users in step 230.

According to a further embodiment, the method includes interacting of the plurality of problem facing users with the plurality of solution providing users through an interaction module in step 240.

According to a further embodiment, the method also includes providing an incentive to the plurality of problem facing users and further providing an inventive to the plurality of solution providing users through an incentive module in step 250.

According to another embodiment, the method further includes transmitting information between the subscription module, the problem broadcast module, the solution broadcast module, the interaction module, and the incentive module via a communication network through a user interface module in step 260.

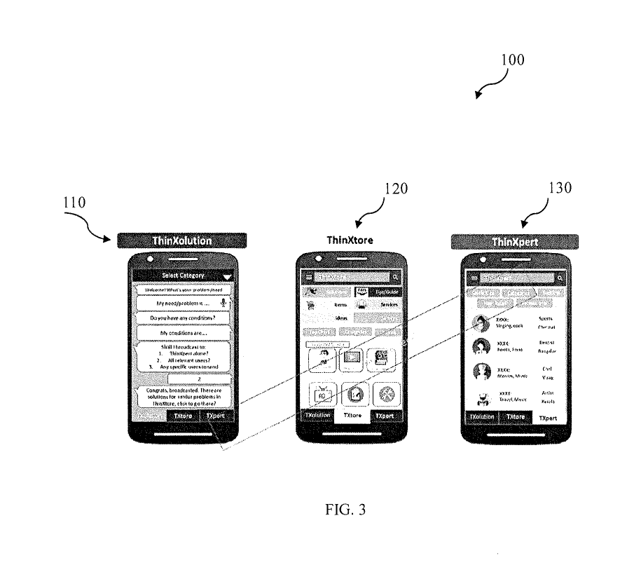

FIG. 3 illustrates an exemplary embodiment of the various user interfaces of an interactive platform for solving a plurality of problems in accordance with an embodiment of the present disclosure. As illustrated in FIG. 3, the ThinXolution is an exemplary view illustrated by 110 of the interaction module (40) wherein the plurality of problem facing users and plurality of solution providing users interact. Further as represented in FIG. 3, ThinXtore illustrated by 120 is an exemplary view of the advertisement module wherein the products and services provided by the plurality of problem facing users and plurality of solution providing users are listed out, in order for any product or service to be redeemed through incentive amounts. As represented in FIG. 3, ThinXpert as illustrated by 130 is an exemplary view of the hall of fame module wherein the hall of fame module is configured to list the plurality of solution providers who possess a higher criterion of ratings. In this way, users may want to choose a solution provided who has a high criterion of rating.

The system and method for an interactive platform for solving a plurality of problems can be used for several solutions or suggestions. The problems or queries may include moral issues, financial issues, legal issues, medical issues, academic issue etc. The level of credibility increases when people showing interest to provide solutions or suggestions are responding to the queries and problems. The interested individuals may include industry experts, academician in the subject or passionate people, who are ready to provide solutions in the interest of the other person.

The system and method for an interactive platform for solving a plurality of problems is advantages as it provides a platform with logic to reward both the plurality of problem facing users and the plurality of solution providing users. This platform also allows the users to exchange their services and or products in lieu of appreciating each other talent by exchanging incentive amounts. This platform also encourages the users by bringing specific users with higher ratings to a hall of fame list.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for an interactive platform for solving a plurality of problems, comprising:
a subscription module configured to register a plurality of problem facing users, and further configured to register a plurality of solution providing users, wherein the subscription module is configured to generate a unique identification code;
a problem broadcast module configured to provide a platform for the plurality of problem facing users to share a plurality of problems, wherein, the platform is configured to publish the plurality of problems, and wherein the plurality of problems is accessed by the plurality of solution providing users;
a solution broadcast module configured to provide a platform for the solution providing users to provide a plurality of solutions, wherein the solution broadcast module is further configured to display the plurality of solutions of the plurality of problems to a specific user of the plurality of problem facing users;
an interaction module configured to provide an interaction between the plurality of problem facing users and the plurality of solution providing users;
an incentive module configured to provide an incentive amount to the plurality of problem facing users and is further configured to provide an incentive amount to the plurality of solution providing users; and
a user interface configured to transmit information between the subscription module, the problem broadcast module, the solution broadcast module, the interaction module, and the incentive module via a communication network.

2. The system for an interactive platform for solving a plurality of problems as claimed in claim 1, wherein the interaction module further comprises a one-on-on interaction module, wherein the one-on-one interaction module is configured to provide a one-on-one interaction between a first specific user of a plurality of problem facing users and a second specific user of a plurality of solution providing users.

3. The system for an interactive platform for solving a plurality of problems as claimed in claim 1 wherein the incentive module further comprises an incentive calculation module, wherein the incentive calculation module is configured to calculate the incentive amount based on a criterion of ratings of the plurality of problem facing user and the plurality of solution providing users.

4. The system for an interactive platform for solving a plurality of problems as claimed in claim 1 further comprises an advertisement module wherein the advertisement module is configured to provide a platform for a plurality of users to advertise a plurality of products and services, wherein the advertisement module is coupled to the incentive module further configured to provide an incentive amount based on an advertisement of the plurality of products and services.

5. The system for an interactive platform for solving a plurality of problems as claimed in claim 1 further comprises a hall of fame module wherein the hall of fame module is configured to list the plurality of solution providers who possess a higher criterion of ratings.

6. A method for an interactive platform for solving a plurality of problems, comprising:
registering a plurality of problem facing users and further registering a plurality of solution providing users through a subscription module, wherein the subscription module is configured to generate a unique identification code;
providing a platform for the plurality of problem facing users to share a plurality of problems through a problem broadcast module, wherein the problem broadcast module is configured to publish the plurality of problems, and wherein the plurality of problems is accessed by the plurality of solution providing users;
providing a platform for the solution providing users to provide a plurality of solutions through a solution broadcast module, wherein the solution broadcast module is further configured to display the plurality of solutions of the plurality of problems to a specific user of the plurality of problem facing users;
interacting of the plurality of problem facing users with the plurality of solution providing users through an interaction module;
providing an incentive to the plurality of problem facing users and further providing an inventive to the plurality of solution providing users through an incentive module; and
transmitting information between the subscription module, the problem broadcast module, the solution broadcast module, the interaction module, and the incentive module via a communication network through a user interface module.

7. The method for an interactive platform for solving a plurality of problems as claimed in claim 6 further comprises of providing a one-on-one interaction between a first specific user of a plurality of problem facing users and a second specific user of a plurality of solution providing users through a one-on-one interaction module.

8. The method for an interactive platform for solving a plurality of problems as claimed in claim 6 further comprises calculating an incentive amount based on a criteria of ratings through an incentive calculation module.

9. The method for an interactive platform for solving a plurality of problems as claimed in claim 6 further comprises advertising a plurality of services and products provided by the plurality of problem facing users and the plurality of solution providing users through an advertisement module, wherein the advertisement module is coupled to the incentive module further configured to provide an incentive amount based on an advertisement of the plurality of products and services.

10. The method for an interactive platform for solving a plurality of problems as claimed in claim 6 further comprises listing a plurality of solution providing users with a higher criterion of ratings in a hall of fame module.
